(19) United States
(12) Patent Application Publication
(10) Pub. No.: US 2014/0324700 A1
(43) Pub. Date: Oct. 30, 2014

(54) METHOD AND SYSTEM FOR PROCESSING OBJECT TO BE PROCESSED

(71) Applicant: TENCENT TECHNOLOGY (SHENZHEN) COMPANY LIMITED, Shenzhen (CN)

(72) Inventors: Xiaolong ZHANG, Shenzhen (CN); Wa YE, Shenzhen (CN); Runda CAI, Shenzhen (CN); Peng LIU, Shenzhen (CN); Xing LIANG, Shenzhen (CN)

(73) Assignee: TENCENT TECHNOLOGY (SHENZHEN) COMPANY LIMITED, Shenzhen (CN)

(21) Appl. No.: 14/299,965

(22) Filed: Jun. 9, 2014

Related U.S. Application Data
(63) Continuation of application No. PCT/CN2013/085159, filed on Oct. 14, 2013.

(30) Foreign Application Priority Data
Apr. 28, 2013 (CN) 2013101578762

(51) Int. Cl. G06Q 20/40; G06Q 20/08

(52) U.S. Cl. CPC G06Q 20/40; G06Q 20/0855
USPC 705/44

(57) ABSTRACT

A method and system for processing an object to be processed are disclosed in the field of Internet communication. In the method, a client device acquires data including: order data of the object to be processed, a first account of a first main body, and a user password. The client device transmits the acquired data to an instant messaging server. The instant messaging server forwards the data to a third party system. The third party system subtracts the total numerical value of the object to be processed from a first numerical value included in the first account of the first main body according to the data and adds the total numerical value to a second numerical value included in a first account of the second main body.

### CROSS-REFERENCE TO RELATED APPLICATIONS

This application is a continuation of International Application No. PCT/CN2013/085159, filed on Oct. 14, 2013, which claims priority to Chinese Patent Application No. 2013101578762, “METHOD AND SYSTEM FOR PROCESSING OBJECT TO BE PROCESSED,” filed on Apr. 28, 2013, which is hereby incorporated by reference in its entirety.

### FIELD

The present disclosure relates generally to the field of Internet communication and, more particularly, to a method and system for processing an object to be processed.

### BACKGROUND

Along with the rapid development of Internet technology, online shopping is becoming increasingly popular. At present, Internet users may purchase merchandises on e-commerce websites, process the purchased merchandises and pay the merchants online for their purchases.

At present, when a user purchases a merchandise on an e-commerce website, the e-commerce website generates a purchase order thereof comprising at least the amount required for the purchase of the merchandise and the merchant ID, and notifies the user of the purchase order; the user then uses his/her own user account and user password to log in a third party system, and submits the purchase order number of the purchase order to the third party system after successful log in; the third party system pays the amount required for the purchase of the merchandise to the merchant, thereby processing the purchased merchandise.

In the process of making the present disclosure, the inventors have discovered that the prior art is associated with the following problems:

When a user processes the purchased merchandise, the user is required to use his/her own user account and user password to log in a third party system, and this results in low efficiency of merchandise processing.

### SUMMARY

To improve the efficiency of processing objects to be processed, the present disclosure provides a method and system for processing an object to be processed.

In one aspect, the present disclosure provides a method for processing an object to be processed. In the method, a client device acquires order data of the object to be processed, a first account of a first main body and a user password thereof, the order data comprising at least the ID of a second main body and the total numerical value of the object to be processed. The client device transmits the order data of the object to be processed, the first account of the first main body and the user password thereof to an instant messaging server. The instant messaging server forwards the order data of the object to be processed, the first account of the first main body and the user password thereof to a third party system. The third party system subtracts the total numerical value of the object to be processed from a first numerical value included in the first account of the first main body according to the order data of the object to be processed, the first account of the first main body and the user password thereof and adds the total numerical value to a second numerical value included in a first account of the second main body.

In another aspect, the present disclosure provides a system for processing an object to be processed. The system includes a client device and an instant messaging server. The client device is configured to acquire order data of the object to be processed, a first account of a first main body and a user password thereof, the order data comprising at least the ID of a second main body and the total numerical value of the object to be processed. The client device is also configured to transmit the order data of the object to be processed, the first account of the first main body and the user password thereof to an instant messaging server. The instant messaging server is configured to forward the order data of the object to be processed, the first account of the first main body and the user password thereof to a third party system so that the third party system updates the first account of the first main body and a first account of the second main body according to the order data of the object to be processed, the first account of the first main body, and the user password thereof.

In this embodiment of the present disclosure, as the client device remains logged in to the instant messaging server after being started, the client device is able to directly transmit the order data of the object to be processed, the first account of the first main body and the user password thereof to the instant messaging server; and as the instant messaging server directly communicates with the third party system via a communication interface therebetween, the instant messaging server is able to directly transmit the order data of the object to be processed, the first account of the first main body and the user password thereof to the third party system, hence the process of logging in to the third party system is left out and the efficiency of processing objects to be processed is improved.

### BRIEF DESCRIPTION OF THE DRAWINGS

To better explain the present disclosure, the accompanying drawings necessary for the illustration of example embodiments of the disclosure are briefly described below, and it is apparent to those of ordinary skill in the art that the accompanying drawings only show some embodiments of the disclosure and that other drawings may be obtained according to the accompanying drawings without any innovative efforts.

FIG. 1 is a process flow diagram of a method for processing an object to be processed according to various embodiments of the present disclosure.

FIG. 2(a) and FIG. 2(b) show a process flow diagram of a method for processing an object to be processed according to various embodiments of the present disclosure.

FIG. 3 is a schematic diagram of a fast processing interface according to various embodiments of the present disclosure.

FIG. 4 is a schematic diagram of a first account input interface according to various embodiments of the present disclosure.

FIG. 5 is a schematic diagram of an identity verification information input interface according to various embodiments of the present disclosure.

FIG. 6 is a schematic diagram of a verification interface according to various embodiments of the present disclosure.

FIG. 7 is a schematic diagram of a user password input interface according to various embodiments of the present disclosure.

FIG. 8 is a process flow diagram of a method for processing an object to be processed according to various embodiments of the present disclosure.

FIG. 9 is a schematic diagram of an authorization interface according to various embodiments of the present disclosure.

FIG. 10 is a schematic diagram of an object details interface according to various embodiments of the present disclosure.

FIG. 11 is a schematic diagram of a mailing address information input interface according to various embodiments of the present disclosure.

FIG. 12 is a schematic diagram of a fast processing interface according to various embodiments of the present disclosure.

FIG. 13 is a schematic block diagram of a system for processing an object to be processed according to various embodiments of the present disclosure.

### DETAILED DESCRIPTION

For a better understanding of the aim, scheme and advantages of the present disclosure, various example embodiments are described in detail in connection with the accompanying drawings as follows. The various embodiments may be combined at least partially if necessary.

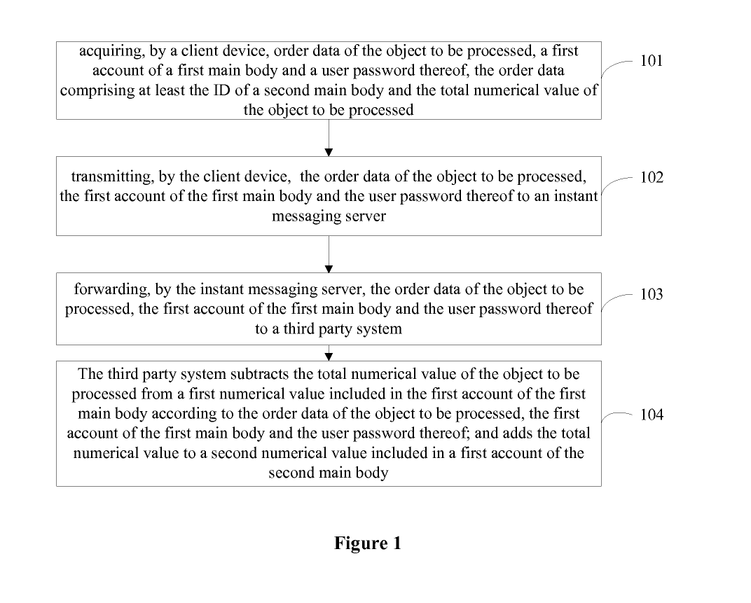

This embodiment of the present disclosure provides a method for processing an object to be processed. As shown in FIG. 1, the method includes:

Step 101: a client device acquires order data of the object to be processed, a first account of a first main body and a user password thereof, the order data comprising at least the ID of a second main body and the total numerical value of the object to be processed;

Step 102: the client device transmits the order data of the object to be processed, the first account of the first main body and the user password thereof to an instant messaging server;

Step 103: the instant messaging server forwards the order data of the object to be processed, the first account of the first main body and the user password thereof to a third party system so that the third party system updates the accounts of the first and second bodies accordingly;

Step 104: the third party system may update the first account of the first main body by subtracting the total numerical value of the object to be processed from a first numerical value included in the first account of the first main body according to the order data of the object to be processed, the first account of the first main body and the user password thereof. After that, the third party system may update the first account of the second main body by adding the total numerical value to a second numerical value included in a first account of the second main body.

In the present disclosure, the client device may include a phone, a smart phone, a tablet, a media player, or any computing device that has a processor and a non-transitory storage medium accessible to the processor. The non-transitory storage medium stores an instant messenger that is configured to communicate with other client devices. As the client device remains logged in to the instant messaging server after being started, the client device is able to directly transmit the order data of the object to be processed, the first account of the first main body and the user password thereof to the instant messaging server; and as the instant messaging server directly communicates with the third party system via a communication interface therebetween, the instant messaging server is able to directly transmit the order data of the object to be processed, the first account of the first main body and the user password thereof to the third party system, hence the process of logging in to the third party system is left out and the efficiency of processing objects to be processed is improved.

In this disclosure, a first main body may be a person or an organization that has a finanicial account in a financial institute and a first instant messaging account in a social network. The first main body may be an online shopper. Similarly, a second main body may be a person or an organization that has a finaicial account in a financial institute and a second instant messaging account in the social network. The second instant messaging account may be a public account in WeChat. The second main body may be an online seller.

This embodiment of the present disclosure provides a method for processing an object to be processed.

For example, when the first main body uses the client device to process the object to be processed, a corresponding relationship between the first account of the first main body and the second account of the first main body is created in the third party system. The first account may be a bank account registered by the first main body in the third party system or a bank system, and the second account of the first main body may be an instant messaging account registered by the first main body in the instant messaging server.

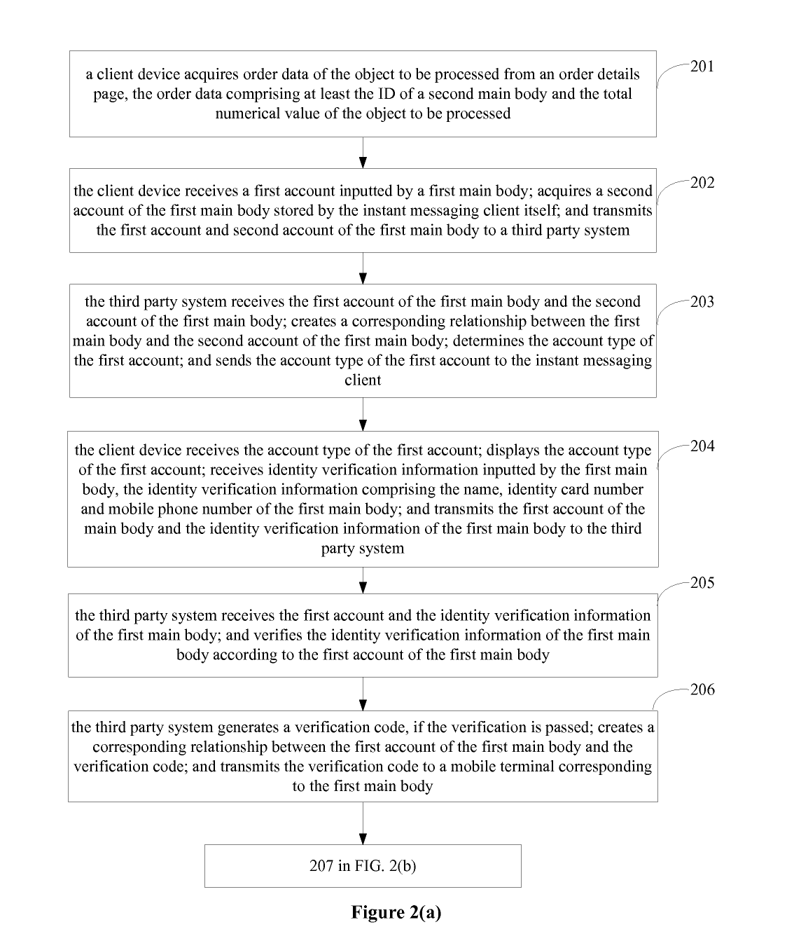

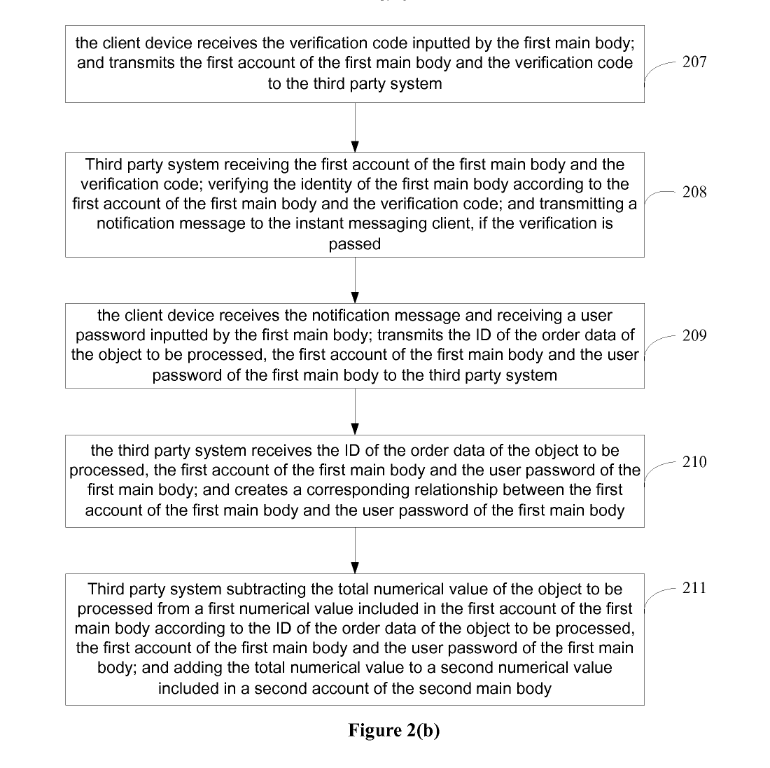

As shown in FIGS. 2(a) and 2(b), when the first main body first uses the client device to process the object to be processed, the following steps 201 through 210 may be performed for processing the object to be processed and for creating a corresponding relationship between the first account of the first main body and the second account of the first main body and a corresponding relationship between the first account of the first main body and the user password of the first main body:

Step 201: client device acquiring order data of the object to be processed from an order details page, the order data comprising at least the ID of a second main body and the total numerical value of the object to be processed.

Here, the first main body may use a mobile terminal to visit a background server of the second main body, the background server of the second main body transmitting an object details page to the mobile terminal, the object details page comprising at least the ID and description information of the object to be processed. The first main body may select the object to be processed from the object details page and select the quantity of the object to be processed, and the mobile terminal transmits the ID and quantity of the object to be processed to the background server of the second main body. The background server of the second main body generates order data of the object to be processed according to the ID of the second main body, the ID and quantity of the object to be processed, the order data comprising at least the ID of the second main body and the total numerical value of the object to be processed; and transmits an order details page to the mobile terminal, the order details page comprising the order data.

The background server of the second main body acquires the ID of the second main body stored by the background server itself, and acquires description information of the object to be processed, and the description information comprises at least a single numerical value of the object to be processed, and may comprise the name and/or color of the object to be processed; computes the total numerical value of the object to be processed according to the quantity of the object to be processed and the single numerical value thereof; generates order data of the object to be processed, and the order data comprises at least the ID of the second main body and the total numerical value of the object to be processed; further, the order data may comprise the description information of the object to be processed and/or the name of the second main body.

The mobile terminal receives the order details page transmitted by the background server of the second main body and displays the received order details page; the first main body may submit a processing command to the order details page, and the order details page may invoke the client device installed at the mobile terminal. The client device acquires order data of the object to be processed from the order details page.

The background server of the second main body also transmits the order data of the object to be processed to a third party system.

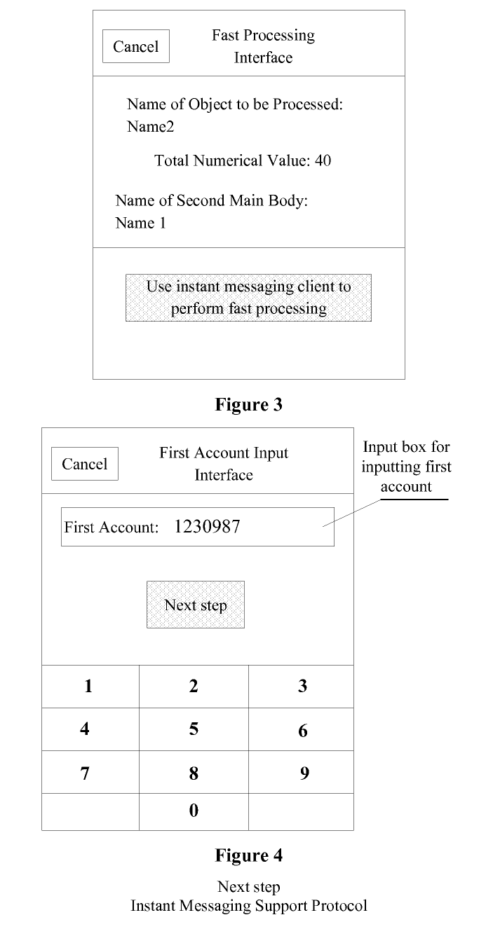

For example, the client device acquires order data of the object to be processed from the order details page, the order data comprising the ID of the second main body, the total numerical value 40 of the object to be processed, the name of the second main body, “Name1,” and the name of the object to be processed, “Name2”; the client device creates a fast processing interface as shown in FIG. 3, the fast processing interface comprising a button “Use client device to perform fast processing” that displays in the fast processing interface the total numerical value 40 of the object to be processed, the name of the second main body “Name1” and the name of the object to be processed “Name2” included in the order data of the object to be processed.

Step 202: client device receiving a first account inputted by a first main body; acquiring a second account of the first main body stored by the client device itself; and transmitting the first account and second account of the first main body to a third party system;

For example, the first account is the account registered by the first main body in the third party system or a bank system, and the second account of the first main body is the account registered by the first main body in the instant messaging server.

For example, the first main body may submit a processing command to the client device by using the button “Use client device to perform fast processing.” The client device receives the command and creates the first account input interface as shown in FIG. 4, the first account input interface comprising an input box for inputting first account and a button “Next step.” The first main body may input the first account of the first main body as “1230987” in the input box for inputting first account and submit a processing command to the client device through the button “Next step.”

The client device receives the command, acquires the first account “1230987” of the first main body from the input box for inputting first account, acquires the second account “456789” of the first main body stored in itself, and transmits the first account “1230987” of the first main body and the second account “456789” of the first main body to the third party system.

Step 203: third party system receiving the first account of the first main body and the second account of the first main body; creating a corresponding relationship between the first main body and the second account of the first main body; determining the account type of the first account; and sending the account type of the first account to the client device.

For example, the third party system receives the first account of the first main body and the second account of the first main body, stores the first account of the first main body and the second account of the first main body in a corresponding relationship between the first account and the second account, determines the numerical range of the first account of the first main body, acquires the account type corresponding to the first account from the corresponding relationship between the stored numerical range and the account type according to the numerical range of the first account, and transmits the account type of the first account to the client device.

For example, the third party system receives the first account “1230987” of the first main body and the second account “456789” of the first main body, stores the first account “1230987” of the first main body and the second account “456789” of the first main body in a corresponding relationship between the first account and the second account as shown in Table 1, determines the account type of the first account “1230987” to be account type 1, and transmits the account type of the first account, account type 1, to the client device.

TABLE 1

| First Account | Second Account |
|---|---|
| 1564888 | 456128 |
| 1665963 | 165648 |
| 1230987 | 456789 |
| . . . | . . . |

Step 204: client device receiving the account type of the first account; displaying the account type of the first account; receiving identity verification information inputted by the first main body, the identity verification information comprising the name, identity card number and mobile phone number of the first main body; and transmitting the first account of the main body and the identity verification information of the first main body to the third party system.

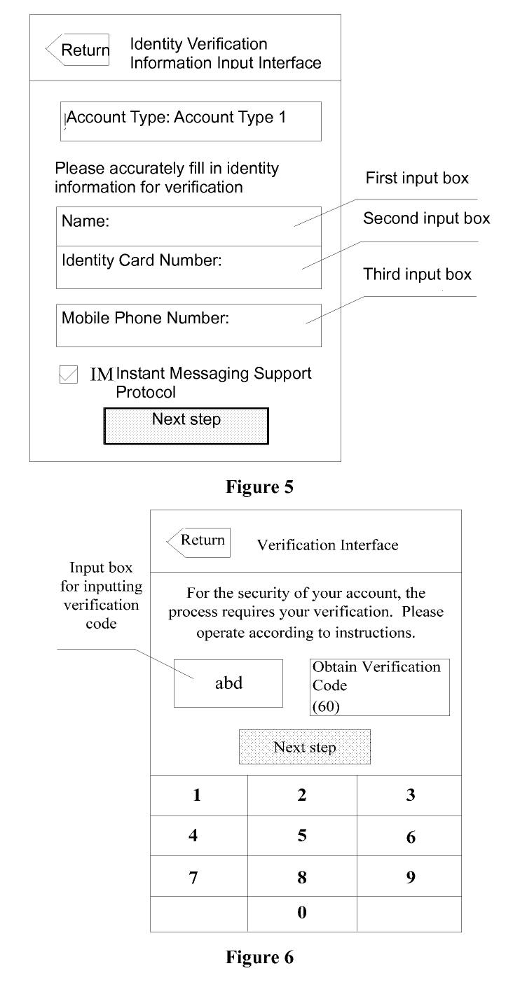

For example, the client device receives the account type of the first account, account type 1; creates an identity verification information input interface as shown in FIG. 5, the identity verification information input interface comprising a first input box for inputting name, a second input box for inputting identity card number, a third input box for inputting mobile phone number, and a button “Next step”; and displays the account type of the first account, account type 1, in the identity verification information input interface.

The first main body inputs the name, the identity card number and the mobile phone number of the first main body in the first input box, the second input box and the third input box respectively; and submits a processing command to the client device through the button “Next step.” The client device receives the command; obtains the identity verification information of the first main body by acquiring the name, the identity card number and the mobile phone number of the first main body from the first input box, the second input box and the third input box respectively; and transmits the first account “1230987” of the first main body and the identity verification information of the first main body to the third party system.

Step 205: third party system receiving the first account and the identity verification information of the first main body; verifying the identity verification information of the first main body according to the first account of the first main body; and performing step 206 if the verification is passed.

For example, the third party system receives the first account and the identity verification information of the first main body; acquires the corresponding identity verification information from the stored corresponding relationship between the first account and the identity verification information according to the first account of the first main body; compares the acquired identity verification information with the identity verification information of the first main body; if the acquired identity verification information is the same as the identity verification information of the first main body, the verification is passed, and if the acquired identity verification information is not the same as the identity verification information of the first main body, the verification is not passed.

Step 206: third party system generating a verification code, if the verification is passed; creating a corresponding relationship between the first account of the first main body and the verification code; and transmitting the verification code to a mobile terminal corresponding to the first main body.

For example, the third party system generates a verification code; creates a corresponding relationship between the first account of the first main body and the verification code; and transmits the verification code to a mobile terminal corresponding to the first main body according to the mobile phone number included in the acquired identity verification information.

For example, the third party system generates a verification code “abd”; creates a corresponding relationship between the first account “1230987” of the first main body and the verification code “abd”; and transmits the verification code “abd” to the mobile terminal corresponding to the first main body.

TABLE 2

| | Verification |
|---|---|
| First Account | Code |
| 1564888 | skd |
| 1665963 | dfs |
| 1230987 | abd |
| . . . | . . . |

The mobile terminal corresponding to the first main body receives the verification code, and the first main body inputs the verification code to the client device.

Step 207: client device receiving the verification code inputted by the first main body; and transmitting the first account of the first main body and the verification code to the third party system.

For example, the client device creates a verification interface as shown in FIG. 6 after receiving the command, the verification interface comprising an input box for inputting verification code and a button “Next step.” The first main body may input the verification code “abd” to the input box for inputting verification code and submit a processing command to the client device through the button “Next step.” The client device receives the command, acquires the verification code “abd” from the input box for inputting verification code, and transmits the first account “1230987” of the first main body and the verification code “abd” to the third party system.

Step 208: third party system receiving the first account of the first main body and the verification code; verifying the identity of the first main body according to the first account of the first main body and the verification code; and transmitting a notification message to the client device, if the verification is passed.

For example, the third party system receives the first account of the first main body and the verification code; acquires the corresponding verification code from the stored corresponding relationship between the first account and the verification code; compares the acquired verification code with the verification code; if the acquired verification code is the same as the verification code of the first main body, the verification is passed and a notification message is transmitted to the client device; and if the acquired verification code is not the same as the verification code of the first main body, the verification is not passed.

For example, the third party system receives the first account “1230987” of the first main body and the verification code “abd”; acquires the corresponding verification code “abd” from the stored corresponding relationship between the first account and the verification code as shown in Table 2 according to the first account “1230987” of the first main body; compares the acquired verification code “abd” with the verification code “abd”; and since the acquired verification code “abd” is the same as the verification code “abd,” the identity verification of the first main body is passed and a notification message is transmitted to the client device.

Step 209: client device receiving the notification message and receiving a user password inputted by the first main body; transmitting the ID of the order data of the object to be processed, the first account of the first main body and the user password of the first main body to the third party system.

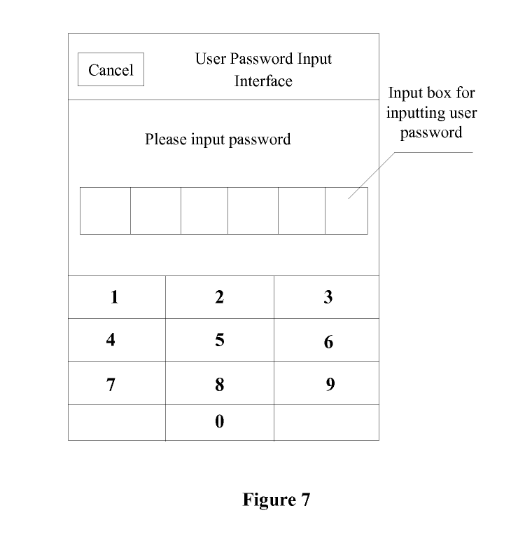

For example, the client device receives the notification message; creates a user password input interface as shown in FIG. 7, the user password input interface comprising an input box for inputting user password and a button “Complete.” The first main body inputs a user password “456” to the input box for inputting user password and submits a processing command to the client device through the button “Complete.” The client device receives the command; acquires the user password “456” from the input box for inputting user password; and transmits the ID of the order data of the object to be processed, the first account “1230987” of the first main body and the user password “456” to the third party system.

Step 210: third party system receiving the ID of the order data of the object to be processed, the first account of the first main body and the user password of the first main body; and creating a corresponding relationship between the first account of the first main body and the user password of the first main body.

For example, the third party system receives the ID of the order data of the object to be processed, the first account “1230987” of the first main body and the user password “456” of the first main body; and stores the first account “1230987” of the first main body and the user password “456” of the first main body in a corresponding relationship between the first account and the user password as shown in Table 3.

TABLE 3

| First Account | User Password |
|---|---|
| 1564888 | 485 |
| 1665963 | 894 |
| 1230987 | 456 |
| . . . | . . . |

Step 211: third party system subtracting the total numerical value of the object to be processed from a first numerical value included in the first account of the first main body according to the ID of the order data of the object to be processed, the first account of the first main body and the user password of the first main body; and adding the total numerical value to a second numerical value included in a second account of the second main body.

For example, the third party system acquires order data of the object to be processed according to the ID of the order data of the object to be processed; acquires a first account of a second main body from the stored corresponding relationship between the ID of the second main body and the first account of the second main body according to the ID of the second main body included in the order data of the object to be processed; the third party system verifies the user password of the first main body according to the stored corresponding relationship between the first account and the user password and the first account of the first main body; and if the verification is passed, the third party system subtracts the total numerical value from a first numerical value included in the first account of the first main body and adds the total numerical value subtracted from the first numerical value included in the first account of the first main body to a second numerical value included in a first account of the second main body.

The third party system verifying the user password of the first main body according to the stored corresponding relationship between the first account and the user password and the first account of the first main body may include: the third party system acquiring the corresponding user password from the stored corresponding relationship between the first account and the user password according to the first account of the first main body; comparing the acquired user password with the user password inputted by the first main body; if the acquired user password is the same as the user password inputted by the first main body, the verification is passed, and if the acquired user password is not the same as the user password inputted by the first main body, the verification is not passed.

In this disclosure, the first main body may directly input the first account of the first main body and the user password thereof to the client device. Then, the client device receives the first account and the user password inputted by the first main body; and transmits the second account, the first account and the user password of the first main body to the third party system. The third party system creates a corresponding relationship between the second account and the first account of the first main body, and creates a corresponding relationship between the first account and the user password of the first main body.

For example, the client device receives the first account and the user password inputted by the first main body; and transmits the second account, the first account and the user password of the first main body to the third party system; the third party system receives the second account, the first account and the user password of the first main body transmitted by the client device; the third party system stores the second account and the first account of the first main body in a corresponding relationship between the second account and the first account; and the third party system stores the first account and the user password of the first main body in a corresponding relationship between the first account and the user password.

The second account of the first main body is an account registered in advance by the first main body in the instant messaging server.

In the present disclosure, the first main body may be a user; the second account of the first main body may be a micro signal; the first account may be a bank card number; the user password may be a payment password; and the third party system may be a third party payment system.

In this embodiment of the present disclosure, the client device receives the first account inputted by the first main body and acquires the second account of the first main body stored in the client device itself after acquiring order data of the object to be processed from the order details page; the client device transmits the first account of the first main body and the second account of the first main body to the third party system; and the third party system creates a corresponding relationship between the first account of the first main body and the second account of the first main body according to the first account of the first main body and the second account of the first main body. Hence the first account of the first main body and the second account of the first main body are bundled in the third party system, and the first main body is not required to input the first account thereof again when the first main body processes the object to be processed through the client device next time, and this improves the efficiency of processing. Also, when bundling the first account of the first main body with the second account of the first main body, the third party system transmits a verification code to the client device, and verifies the identity of the first main body according to the verification code, thereby ensuring the security of the first account of the first main body.

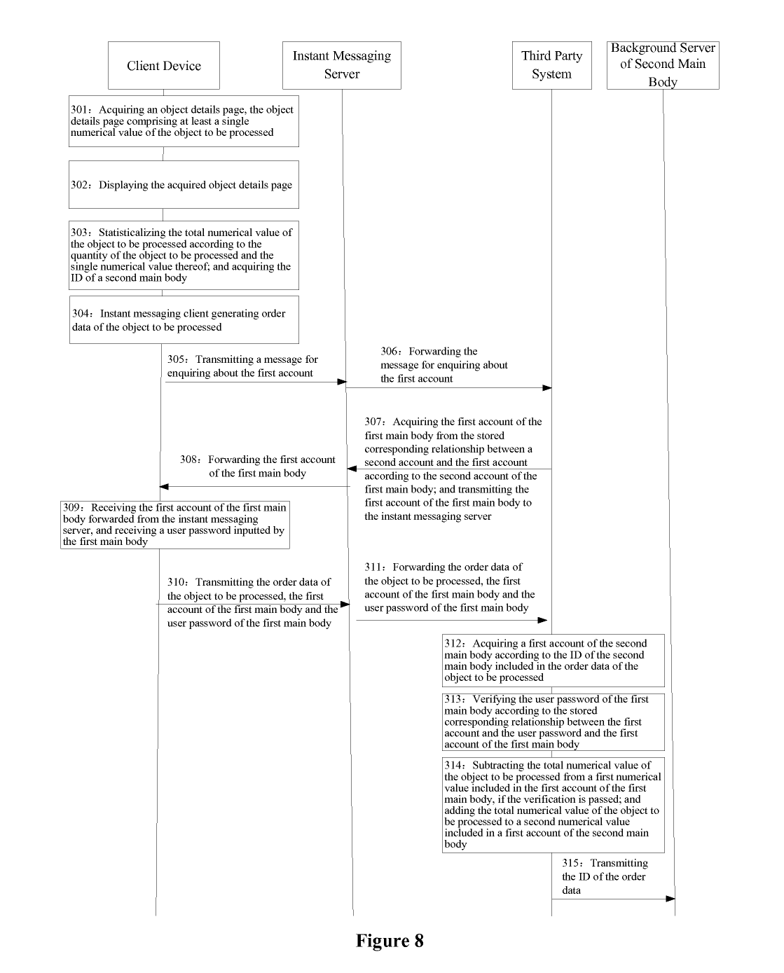

As shown in FIG. 8, if the first main body again selects an object to be processed after the third party system creates a corresponding relationship between the first account of the first main body and the second account of the first main body and a corresponding relationship between the first account and the user password of the first main body, the client device may be used to process the object to be processed and the method comprises:

Step 301: client device acquiring an object details page, the object details page comprising at least a single numerical value of the object to be processed.

For example, this step may be implemented in two ways as follows:

First, the client device receives object information transmitted by a background server of the second main body through a second account of the second main body, the object information comprising at least a link to the object details page; the client device acquires the object details page according to the link to the object details page, the object details page comprising at least a single numerical value of the object to be processed.

For example, the background server of the second main body transmits the object information to the instant messaging server via the second account of the second main body. The instant messaging server acquires the second account of the first main body from the stored corresponding relationship between the second account of the second main body and the second account of the first main body according to the second account of the second main body; the instant messaging server transmits the object information to the client device according to the acquired second account of the first main body, the object information comprising at least a link to the object details page. The client device acquires the object details page from the background server of the second main body according to the link to the object details page, the object details page comprising at least a single numerical value of the object to be processed.

The background server of the second main body generates the object details page in advance according to the object information and assigns a link to the object details page; and the background server of the second main body bundles the object details page of the object information with the link to the object details page.

The second account of the second main body is an account registered in advance by the second main body in the instant messaging server; and the instant messaging server stored the second account of the second main body and the second account of the first main body in a corresponding relationship between the second account of the second main body and the second account of the first main body after the first main body adds the second account of the second main body.

The second account of the second main body may be an instant messaging public ID of the second main body.

Second, the client device scans the graphic code of the object to be processed, and acquires a link to the object details page from the graphic code of the object to be processed; the client device acquires the object details page according to the link to the object details page, the object details page comprising at least a single numerical value of the object to be processed.

For example, the client device scans the graphic code of the object to be processed, and acquires a link to the object details page from the graphic code of the object to be processed; the client device acquires the object details page from the background server of the second main body according to the link to the object details page of the object to be processed, the object details page comprising at least a single numerical value of the object to be processed.

The background server of the second main body generates the object details page in advance according to the object information and assigns a link to the object details page; the background server of the second main body transmits the link to the object details page to the instant messaging server; the instant messaging server generates a graphic code according to the link to the object details page and transmits the generated graphic code to the background server of the second main body; and the background server of the second main body pastes the graphic code on a carrier of the object to be processed.

The carrier of the object to be processed may be an advertisement page or a web page of the object to be processed.

The graphic code of the object to be processed may further comprise the ID and/or name of the second main body.

In the aforementioned two ways of implementation, the object details page may further comprise description information of the object to be processed, and the description information may comprise the name and/or ID of the second main body and the name, ID and/or color of the object to be processed.

Alternatively, in the aforementioned two ways of implementation, the client device displays an authorization interface after the background server of the second main body assigns a link to the object details page, so that the first main body is able to authorize the client device to process the object to be processed through the authorization interface.

The graphic code of the object to be processed may further comprise the second account of the second main body, and when the client device scans the graphic code of the object to be processed, the client device acquires the second account of the second main body from the graphic code. The client device judges whether the first main body has added the second account of the second main body; if the first main body has added the second account of the second main body, the option “Authorize client device” is displayed in the authorization interface, and if the first main body has not added the second account of the second main body, the option “Authorize client device” and the option “Add the second account of the second main body” are displayed in the authorization interface.

In this disclosure, the second main body may be a merchant. When the second main body is a merchant, the object to be processed may be a merchandise. The object details page may be a merchandise details page, the single numerical value of the object to be processed may be the unit price of the merchandise.

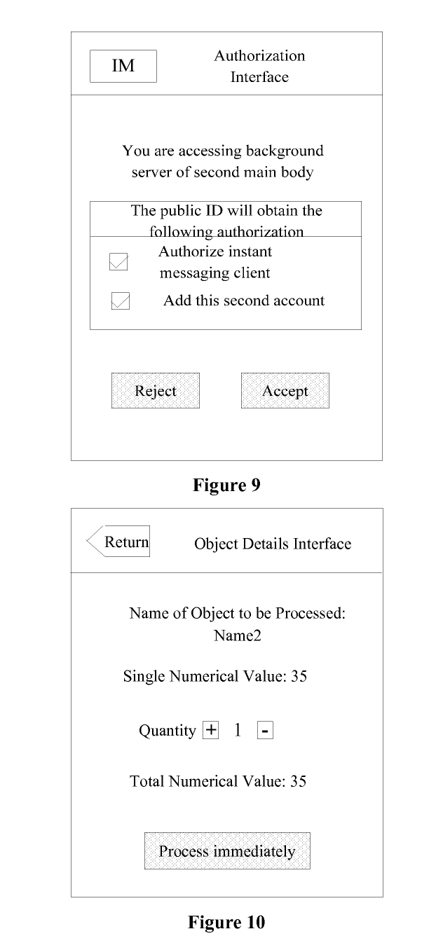

For example, after the background server of the second main body assigns a link to the object details page, the client device displays an authorization interface as shown in FIG. 9. The authorization interface comprises the option “Authorize client device” allowing the first main body to authorize the use of the client device for processing the object to be processed and the option “Add the second account of the second main body.” When authorizing the client device and using the client device to process the object to be processed, the first main body may tick the checkbox against the option “Authorize client device” and submit a processing command to the client device through the button “Accept.” The client device receives the command and thereby acquires an object details page as shown in FIG. 10.

Step 302: client device displaying the acquired object details page, causing the first main body to select the object to be processed from the object details page displayed by the client device.

The first main body selects the object to be processed from the object details page displayed by the client device, and submits the selected object to the client device as the object to be processed.

For example, the client device displays the object details page as shown in FIG. 10 to the first main body, the object details page comprising the name “Name2” of the object to be processed, the singular numerical value 35 of the object to be processed, a button “+” for increasing the quantity of the object to be processed and a button “−” for reducing the quantity of the object to be processed. The first main body may increase the quantity of the object to be processed through the button “+” and reduce the quantity of the object to be processed through the button “−.” After selecting the quantity of the object to be processed, the first main body submits a command to the client device through the button “Process immediately.”

Step 303: client device obtains the total numerical value of the object to be processed according to the quantity of the object to be processed and the single numerical value thereof; and acquiring the ID of a second main body.

For example, the client device computes the total numerical value of the object to be processed according to the quantity of the object to be processed and the single numerical value thereof. The client device transmits the object to be processed to the background server of the second main body; and the background server of the second main body acquires the ID of the second main body according to the received object and transmits the ID of the second main body to the client device.

Step 304: client device generating order data of the object to be processed, the order data comprising at least the ID of the second main body and the total numerical value of the object to be processed.

For example, the client device generates order data according to the ID of the second main body and the total numerical value of the object to be processed, and assigns an ID to the generated order data, the assigned ID being configured to uniquely identify the generated order data; the client device takes the generated order data as the order data of the object to be processed, the order data comprising at least the ID of the second main body and the total numerical value of the object to be processed.

Further, the order data may further comprise description information of the object to be processed, the name of the second main body and/or the mailing address information of the first main body.

Further, when the first main body submits the object to be processed to the client device, the client device judges whether the mailing address information of the first main body is stored therein, the mailing address information of the first main body comprising at least the name, region, detailed address, postcode and contact phone number of the first main body. When the mailing address information of the first main body is not stored in the client device, the client device displays a mailing address information interface to the first main body causing the first main body to input the mailing address information thereof to the mailing address information interface, and stores the mailing address information inputted by the first main body; when the mailing address information of the first main body is stored in the client device, the mailing address information of the first main body stored in the client device is acquired. If the first main body wishes to amend the mailing address information thereof, the client device receives the amended mailing address information inputted by the first main body, and amends the stored mailing address information of the first main body to the amended mailing address information.

The mailing address information of the first main body may be stored in the client device or the instant messaging server.

When the mailing address information of the first main body is stored in the client device, the client device may directly acquire the mailing address information of the first main body.

When the mailing address information of the first main body is stored in the instant messaging server, a corresponding relationship between the second account of the first main body and the mailing address information of the first main body may be stored in the instant messaging server, and when the client device acquires the mailing address information of the first main body, the client device may transmit an acquisition request to the instant messaging server, the acquisition request carrying the second account of the first main body. The instant messaging server receives the acquisition request, acquires the mailing address information of the first main body from the corresponding relationship between the second account and the mailing address information according to the second account of the first main body; and the instant messaging server transmits the acquired mailing address information of the first main body to the client device.

The postcode included in the mailing address information of the first main body may be acquired in the following way.

When the first main body inputs the detailed address thereof to the mailing address information interface, the first terminal determines the region in which the detailed address is located according to the detailed address, acquires the corresponding postcode from the stored corresponding relationship between the region and the postcode according to the region, obtains the number of first main bodies using the acquired postcode; and recommends to the first main body the postcode with the first number larger than the preset threshold.

When the second main body is a merchant, the ID of the second main body may be a merchant name; and when the object to be processed is a merchandise, the total numerical value of the object to be processed may be the total amount to be paid for the merchandise.

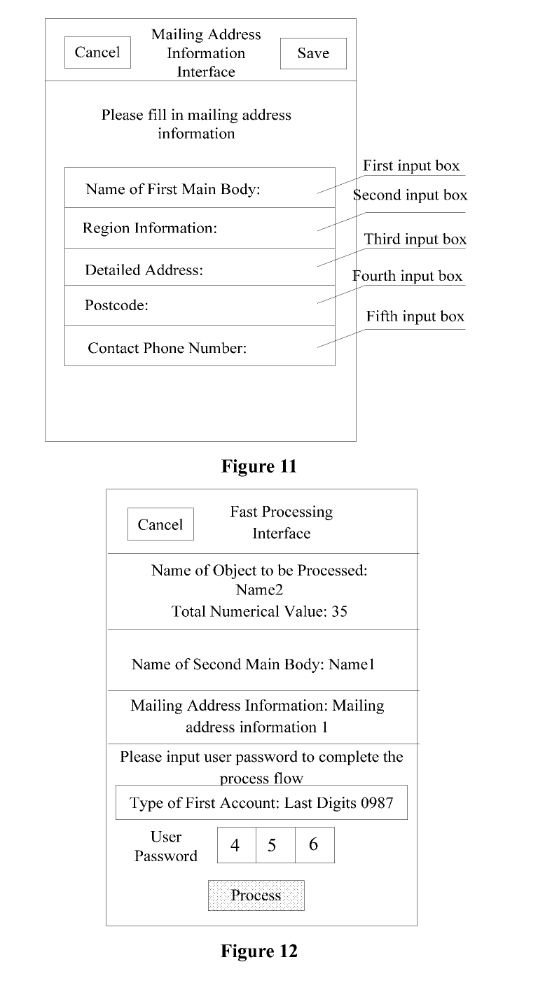

For example, the client device receives the object to be processed and judges that the mailing address information of the first main body is not stored therein, then the client device creates a mailing address information interface as shown in FIG. 11, the mailing address information interface comprising a first input box for inputting the name of the first main body, a second input box for inputting region information, a third input box for inputting detailed address, a fourth input box for inputting postcode and a fifth input box for inputting contact phone number. After filling in the mailing address information, the first main body submits command to the client device through the button “Save.” The client device receives the command; computes the total numerical value of the object to be processed according to the quantity of the object to be processed and the single numerical value thereof; encapsulates the ID of the second main body, the total numerical value of the object to be processed and the mailing address information of the first main body into order data; and transmits the order data to the client device.

Step 305: client device transmitting a message for enquiring about the first account to the instant messaging server.

Step 306: instant messaging server receiving the message and forwarding the message to a third party system, the message carrying the second account of the first main body.

Alternatively, the first main body may directly input the first account of the first main body in the client device and submit the inputted first account to the client device; the client device transmits the first account inputted by the first main body to the instant messaging server; the instant messaging serve receives the first account of the first main body, and forwards the first account of the first main body to a third party system.

Step 307: third party system receiving the message; acquiring the first account of the first main body from the stored corresponding relationship between a second account and the first account according to the second account of the first main body; and transmitting the first account of the first main body to the instant messaging server.

Step 308: instant messaging server receiving the first account of the first main body and forwarding the first account of the first main body to the client device.

After receiving the first account of the first main body transmitted from the instant messaging server, the third party system determines the numerical range of the first account according to the first account of the first main body, acquires the account type corresponding to the first account from the corresponding relationship between the stored numerical range and the account type according to the numerical range of the first account, acquires the last digits of the preset value of the first account of the first main body, and transmits the account type of the first account of the first main body and the last digits of the preset value of the first account of the first main body to the instant messaging server, so that the instant messaging server is caused to forward the account type of the first account of the first main body and the last digits of the preset value of the first account of the first main body to the client device.

Step 309: client device receiving the first account of the first main body forwarded from the instant messaging server, and receiving a user password inputted by the first main body.

Alternatively, the first main body may directly input the first account of the first main body and the user password of the first main body in the client device and submit the inputted first account and user password to the client device.

For example, as shown in FIG. 12, the client device creates a fast processing interface, the fast processing interface comprising Name of Object to be Processed, “Name2”; Total Numerical Value 35; Name of Second Main Body, “Name1”; quantity of the object to be processed; mailing address information; the account type of the first account of the first main body and the last digits of the present value of the first account. Assuming that the preset value is 4 and the last 4 digits of the first account of the first main body are 0987, when the first main body inputs the user password and submits the user password to the client device through the button “Process,” Step 310 is performed.

Step 310: client device transmitting the order data of the object to be processed, the first account of the first main body and the user password of the first main body to the instant messaging server.

Step 311: instant messaging server forwarding the order data of the object to be processed, the first account of the first main body and the user password of the first main body to the third party system.

For example, the instant messaging server receives the order data of the object to be processed, the first account of the first main body and the user password of the first main body transmitted from the client device; and forwards the order data of the object to be processed, the first account of the first main body and the user password of the first main body to the third party system via a communication interface therebetween.

Step 312: third party system acquiring a first account of the second main body according to the ID of the second main body included in the order data of the object to be processed.

For example, the third party system receives the order data of the object to be processed, the first account of the first main body and the user password of the first main body forwarded from the instant messaging server; and acquires the first account of the second main body from the stored corresponding relationship between the ID of the second main body and the first account of the second main body according to the ID of the second main body included in the order data of the object to be processed.

Step 313: third party system verifying the user password of the first main body according to the stored corresponding relationship between the first account and the user password and the first account of the first main body.

For example, the third party system acquires the user password of the first account of the first main body from the stored corresponding relationship between the first account and the user password according to the received first account of the first main body; compares the user password inputted by the first main body and the acquired user password; if the user password inputted by the first main body is the same as the acquired user password, the verification is passed, and if the user password inputted by the first main body is not the same as the acquired user password, the verification is not passed.

Step 314: third party system subtracting the total numerical value of the object to be processed from a first numerical value included in the first account of the first main body, if the verification is passed; and adding the total numerical value of the object to be processed to a second numerical value included in a first account of the second main body.

For example, if verification of the user password of the first main body is passed, the third party system subtracts the total numerical value of the object to be processed from a first numerical value included in the first account of the first main body, and adds the total numerical value of the object to be processed to a second numerical value included in a first account of the second main body.

Further, if verification of the user password of the first main body is not passed, then the first numerical value included in the first account of the first main body remains unchanged and the second numerical value included in the first account of the second main body also remains unchanged.

Further, the third party system transmits a notification message to the instant messaging server; the instant messaging server receives the notification message and forwards the notification message to the client device so that the first main body can determine that processing of the object to be processed has been completed.

Further, the background server of the second main body may transmit a successful processing message to the client device through the second account of the second main body.

Step 315: third party system transmitting the ID of the order data to the background server of the second main body.

The third party system transmits the ID of the order data to the background server of the second main body; the background server of the second main body acquires the order data of the object to be processed according to the ID of the order data, and acquires the mailing address information of the first main body from the order data of the object to be processed; and the second main body mails the object to be processed to the first main body according to the mailing address information of the first main body.

Further, the third party system may also transmit the second account or open identity (openID) of the first main body to the background server of the second main body. The background server of the second main body acquires tracing information of the object to be processed according to the ID of the order data, and transmits the tracing information of the object to be processed to the client device according to the second account or open identity of the first main body.

After the first main body uses the client device to add the second account of the second main body, the background server of the second main body assigns an open identity for the client device of the first main body, the open identity uniquely identifying the client device of the first main body.

In this embodiment of the present disclosure, the client device transmits order data of the object to be processed, the first account of the first main body and the user password of the main body to the instant messaging server, so that the instant messaging server is caused to forward them to the third party system, and the third party system subtracts the total numerical value of the object to be processed from a first numerical value included in the first account of the first main body and adds the total numerical value to a second numerical value included in a first account of the second main body. As the client device remains logged in to the instant messaging server after being started, the client device is able to directly transmit the order data of the object to be processed, the first account of the first main body and the user password thereof to the instant messaging server; and as the instant messaging server directly communicates with the third party system via a communication interface therebetween, the instant messaging server is able to directly transmit the order data of the object to be processed, the first account of the first main body and the user password thereof to the third party system, hence the process of logging in to the third party system is left out and the efficiency of processing objects to be processed is improved.

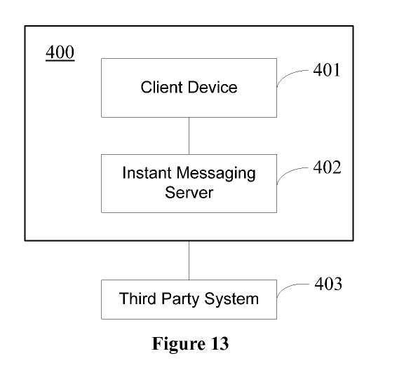

This embodiment of the present disclosure provides a system for processing an object to be processed. As shown in FIG. 13, the system 400 includes: a client device 401 and an instant messaging server 402. The system 400 communicates with a third party system 403.

The client device 401 is configured to acquire order data of the object to be processed, a first account of a first main body and a user password thereof, the order data comprising at least the ID of a second main body and the total numerical value of the object to be processed.

The client device 401 is also configured to transmit the order data of the object to be processed, the first account of the first main body and the user password thereof to the instant messaging server.

The instant messaging server 402 is configured to forward the order data of the object to be processed, the first account of the first main body and the user password thereof to the third party system.

The third party system 403 is configured to subtract the total numerical value of the object to be processed from a first numerical value included in the first account of the first main body according to the order data of the object to be processed, the first account of the first main body and the user password thereof; and add the total numerical value to a second numerical value included in a first account of the second main body.

For instance, the client device 401 is configured to acquire an object details page, the object details page comprising at least a single numerical value of the object to be processed, causing the first main body to select the object to be processed from the object details page.

The client device 401 is also configured to obtain the total numerical value of the object to be processed according to the quantity of the object to be processed and the single numerical value thereof; and acquiring the ID of a second main body.

The client device 401 is also configured to generate order data of the object to be processed, the order data comprising at least the ID of the second main body and the total numerical value of the object to be processed.

The client device 401 may be configured to receive object information transmitted by a background server of the second main body through a second account of the second main body, the object information comprising at least a link to the object details page.

The client device 401 is also configured to acquire the object details page according to the link to the object details page.

Further, the client device 401 is configured to scan graphic code of the object to be processed, and acquiring a link to the object details page from the graphic code.

The second account of the second main body is an account registered by the second main body in the instant messaging server.

The client device 401 is also configured to acquire the object details page according to the link to the object details page.

The client device 401 is also configured to determine whether the mailing address information of the first main body has been stored, acquiring the stored mailing address information of the first main body if the mailing address information of the first main body has been stored, and receive the mailing address information inputted by the first main body if the mailing address information of the first main body has not been stored.

The client device 401 is also configured to receive the amended mailing address information inputted by the first main body if the first main body amends the mailing address information of the first main body, and update the stored mailing address information of the first main body to the amended mailing address information.

The client device 401 is also configured to store the mailing address information inputted by the first main body.

The client device 401 is configured to acquire a first account of the first main body according to a second account of the first main body, and receiving a user password inputted by the first main body.

The second account of the first main body is an account registered by the first main body in the instant messaging server. Or,

The client device 401 is configured to receive a first account and a user password inputted by the first main body.

Further, the client device 401 is configured to transmit a message for enquiring about the first account to an instant messaging server, causing the instant messaging server to forward the message for enquiring about the first account to a third party system, the message carrying the second account of the first main body.

The third party system 403 is configured to acquire the first account of the first main body from the stored corresponding relationship between a second account and the first account according to the second account of the first main body; and transmitting the first account of the first main body to the instant messaging server, causing the instant messaging server to forward the first account of the first main body to the client device.

The client device 401 is also configured to receive the first account of the first main body.

The third party system 403 is configured to acquire a first account of the second main body according to the ID of the second main body included in the order data.

The third party system 403 is also configured to verify the user password of the first main body according to the stored corresponding relationship between the first account and the user password, and the first account of the first main body.

The third party system 403 is also configured to subtract the total numerical value from a first numerical value included in the first account of the first main body, if the verification is passed; and add the total numerical value to a second numerical value included in a first account of the second main body.

Further, the client device 401 is also configured to transmit the second account, the first account and the user password of the first main body to the third party system, causing the third party system to create a corresponding relationship between the second account of the first main body and the first account of the first main body and to create a corresponding relationship between the first account of the first main body and the user password.

In this embodiment of the present disclosure, as the client device remains logged in to the instant messaging server after being started, the client device is able to directly transmit the order data of the object to be processed, the first account of the first main body and the user password thereof to the instant messaging server; and as the instant messaging server directly communicates with the third party system via a communication interface therebetween, the instant messaging server is able to directly transmit the order data of the object to be processed, the first account of the first main body and the user password thereof to the third party system, hence the process of logging in to the third party system is left out and the efficiency of processing objects to be processed is improved.

It must be noted that while the method for processing objects to be processed provided by the foregoing embodiment is illustrated in connection with the division of the various functional modules, in actual application the aforesaid functions may be completed by different functional modules depending on the needs, i.e. the internal structure of the apparatus is divided into different functional modules to complete all or some of the functions. In addition, the apparatus for real-time data updating provided by the foregoing embodiment and the embodiments of the method for real-time data updating have the same concept, and their implementations are described in detail in the embodiments of the method.

The arrangement of the foregoing embodiments is merely intended to facilitate illustration of the present disclosure and does not signify the quality of the embodiments.

It should be understood by those with ordinary skill in the art that all or some of the steps of the foregoing embodiments may be completed by hardware, and may also be completed by hardware instructed by program, the program being stored in a computer-readable storage medium, and the computer readable storage medium being a read-only memory, a magnetic disk or a compact disk.

Disclosed above are only example embodiments of the present disclosure and these example embodiments are not intended to be limiting the scope of the present disclosure, hence any variations, modifications or replacements made without departing from the spirit of the present disclosure shall fall within the scope of the present disclosure.

What is claimed is:

1. A method for processing an object to be processed, comprising:
acquiring, by a client device, order data of the object to be processed, a first account of a first main body, and a user password of the first main body, the order data comprising at least an ID of a second main body and a total numerical value of the object to be processed;
transmitting, by the client device, the order data of the object to be processed, the first account of the first main body and the user password to an instant messaging server;
forwarding, by the instant messaging server, the order data of the object to be processed, the first account of the first main body and the user password to a third party system;
subtracting, by the third party system, the total numerical value of the object to be processed from a first numerical value included in the first account of the first main body according to the order data of the object to be processed, the first account of the first main body and the user password; and
adding, by the third party system, the total numerical value to a second numerical value included in a first account of the second main body.

2. The method of claim 1, wherein the client device acquires order data of the object to be processed comprises:
acquiring, by the client device, an object details page, the object details page comprising at least a single numerical value of the object to be processed, causing the first main body to select the object to be processed from the object details page;
obtaining, by the client device, the total numerical value of the object to be processed according to the quantity of the object to be processed and the single numerical value; and
acquiring the ID of a second main body;
generating, by the client device, order data of the object to be processed, the order data comprising at least the ID of the second main body and the total numerical value of the object to be processed.

3. The method of claim 2, wherein the client device acquires an object details page comprises:
receiving, by the client device, object information transmitted by a background server of the second main body through a second account of the second main body, the object information comprising at least a link to the object details page;
acquiring, by the client device, the object details page according to the link to the object details page.

4. The method of claim 2, wherein the client device acquires an object details page comprises:
scanning, by the client device, the graphic code of the object to be processed, and acquiring a link to the object details page from the graphic code;
acquiring, by the client device, the object details page according to the link to the object details page.

5. The method of claim 2, wherein the order data further comprises mailing address information of the first main body, and that the method further comprises the following step before the client device generating order data of the object to be processed:
determining, by the client device, whether the mailing address information of the first main body has been stored, acquiring the stored mailing address information of the first main body if the mailing address information of the first main body has been stored, and receiving the mailing address information inputted by the first main body if the mailing address information of the first main body has not been stored.

6. The method of claim 5, further comprising the following step after acquiring the stored mailing address information of the first main body:
receiving, by the client device, the amended mailing address information inputted by the first main body if the first main body amends the mailing address information of the first main body, and updating the stored mailing address information of the first main body to the amended mailing address information.

7. The method of claim 5, further comprising the following step after receiving the mailing address information inputted by the first main body:
storing, by the client device, the mailing address information inputted by the first main body.

8. The method of claim 1, wherein the client device acquires the first account of the first main body and the user password comprises:
acquiring, by the client device, a first account of the first main body according to a second account of the first main body, and receiving the user password inputted by the first main body; or
receiving, by the client device, a first account and the user password inputted by the first main body.

9. The method of claim 8, wherein the client device acquiring a first account of the first main body according to a second account of the first main body comprises:
transmitting, by the client device, a message for enquiring about the first account to an instant messaging server, causing the instant messaging server to forward the message for enquiring about the first account to a third party system, the message carrying the second account of the first main body;
acquiring, by the third party system, the first account of the first main body from the stored corresponding relationship between a second account and the first account according to the second account of the first main body; and transmitting the first account of the first main body to the instant messaging server, causing the instant messaging server to forward the first account of the first main body to the client device;
receiving, by the client device, the first account of the first main body.

10. The method of claim 1, wherein the third party system subtracts the total numerical value of the object to be processed from a first numerical value included in the first account of the first main body according to the order data of the object to be processed, the first account of the first main body and the user password; and adding the total numerical value to a second numerical value included in a first account of the second main body; comprises:
acquiring, by the third party system, a first account of the second main body according to the ID of the second main body included in the order data;
verifying, by the third party system, the user password of the first main body according to the stored corresponding relationship between the first account and the user password, and the first account of the first main body;
subtracting, by the third party system, the total numerical value from a first numerical value included in the first account of the first main body, if the verification is passed; and adding the total numerical value to a second numerical value included in a first account of the second main body.

11. The method of claim 1, further comprising the following step before the client device transmits the order data of the object to be processed, the first account of the first main body and the user password to an instant messaging server:
transmitting, by the client device, the second account, the first account and the user password of the first main body to the third party system, causing the third party system to create a corresponding relationship between the second account of the first main body and the first account of the first main body and to create a corresponding relationship between the first account of the first main body and the user password.

12. A system for processing an object to be processed, comprising a client device and an instant messaging server, wherein:
the client device is configured to acquire order data of the object to be processed, a first account of a first main body and a user password of the first main body, the order data comprising at least the ID of a second main body and the total numerical value of the object to be processed;
the client device is further configured to transmit the order data of the object to be processed, the first account of the first main body and the user password to the instant messaging server;
the instant messaging server is configured to forward the order data of the object to be processed, the first account of the first main body and the user password to a third party system so that the third party system updates the first account of the first main body and a first account of the second main body according to the order data of the object to be processed, the first account of the first main body, and the user password.

13. The system of claim 12, wherein:
the client device is configured to acquire an object details page, the object details page comprising at least a single numerical value of the object to be processed, causing the first main body to select the object to be processed from the object details page;
the client device is further configured to obtain the total numerical value of the object to be processed according to the quantity of the object to be processed and the single numerical value; and acquiring the ID of a second main body;
the client device is further configured to generate order data of the object to be processed, the order data comprising at least the ID of the second main body and the total numerical value of the object to be processed.

14. The system of claim 13, wherein:
the client device is configured to receive object information transmitted by a background server of the second main body through a second account of the second main body, the object information comprising at least a link to the object details page;
the client device is further configured to acquire the object details page according to the link to the object details page.

15. The system of claim 13, wherein:
the client device is configured to scan graphic code of the object to be processed, and acquiring a link to the object details page from the graphic code;
the client device is further configured to acquire the object details page according to the link to the object details page.

16. The system of claim 13, wherein:
the client device is further configured to determine whether the mailing address information of the first main body has been stored, acquiring the stored mailing address information of the first main body if the mailing address information of the first main body has been stored, and receiving the mailing address information inputted by the first main body if the mailing address information of the first main body has not been stored.

17. The system of claim 16, wherein:
the client device is further configured to receive the amended mailing address information inputted by the first main body if the first main body amends the mailing address information of the first main body, and updating the stored mailing address information of the first main body to the amended mailing address information.

18. The system of claim 16, wherein:
the client device is further configured to store the mailing address information inputted by the first main body.

19. The system of claim 12, wherein:
the client device is configured to acquire a first account of the first main body according to a second account of the first main body, and receiving a user password inputted by the first main body; or
the client device is configured to receive a first account and a user password inputted by the first main body.

20. The system of claim 19, wherein:
the client device is configured to transmit a message for enquiring about the first account to the instant messaging server, causing the instant messaging server to forward the message for enquiring about the first account to a third party system, the message carrying the second account of the first main body;
the third party system is configured to acquire the first account of the first main body from the stored corresponding relationship between a second account and the first account according to the second account of the first main body; and transmitting the first account of the first main body to the instant messaging server, causing the instant messaging server to forward the first account of the first main body to the client device;
the client device is further configured to receive the first account of the first main body.

21. The system of claim 12, wherein:
the third party system is configured to acquire a first account of the second main body according to the ID of the second main body included in the order data;
the third party system is further configured to verify the user password of the first main body according to the stored corresponding relationship between the first account and the user password, and the first account of the first main body;
the third party system is further configured to subtract the total numerical value from a first numerical value included in the first account of the first main body, if the verification is passed; and adding the total numerical value to a second numerical value included in a first account of the second main body.

22. The system of claim 12, wherein:
the client device is further configured to transmit the second account, the first account and the user password of the first main body to the third party system, causing the third party system to create a corresponding relationship between the second account of the first main body and the first account of the first main body and to create a corresponding relationship between the first account of the first main body and the user password.
